(19) United States
(12) Patent Application Publication
(10) Pub. No.: US 2025/0037929 A1
(43) Pub. Date: Jan. 30, 2025

(54) COIL ELECTRONIC COMPONENT

(71) Applicant: SAMSUNG ELECTRO-MECHANICS CO., LTD., Suwon-si (KR)

(72) Inventors: Seungho Han, Suwon-si (KR); Jongwook Lee, Suwon-si (KR); Boumseock Kim, Suwon-si (KR); Sangjun Lee, Suwon-si (KR); Jongsuk Jung, Suwon-si (KR); Hyun-Kyu Im, Suwon-si (KR)

(73) Assignee: SAMSUNG ELECTRO-MECHANICS CO., LTD., Suwon-si (KR)

(21) Appl. No.: 18/784,234

(22) Filed: Jul. 25, 2024

(30) Foreign Application Priority Data
Jul. 27, 2023 (KR) 10-2023-0097959

(51) Int. Cl. H01F 27/29; H01F 17/00; H01F 27/32

(52) U.S. Cl. CPC H01F 27/292; H01F 17/0013; H01F 27/324

(57) ABSTRACT

A coil electronic component may include a magnetic body including first and second surfaces facing each other in a first direction, third and fourth surfaces facing each other in a second direction and connecting the first surface and the second surface, and fifth and sixth surfaces facing each other in a third direction and connecting the first surface and the second surface, a coil embedded in the magnetic body, a first external electrode disposed on the sixth surface and extending onto a portion of the first surface and connected to the coil, a second external electrode disposed on the sixth surface and extending onto a portion of the second surface and connected to the coil, a first insulation layer covering the first external electrode on the first surface of the magnetic body, and a second insulation layer covering the second external electrode on the second surface of the magnetic body.

### CROSS-REFERENCE TO RELATED APPLICATION

The present application claims the benefit of priority to Korean Patent Application No. 10-2023-0097959 filed on Jul. 27, 2023 in the Korean Intellectual Property Office, the entire contents of which is incorporated herein by reference.

### TECHNICAL FIELD

The present disclosure relates to a coil electronic component.

### BACKGROUND

Recently, as the functions of mobile devices diversify, power consumption increases, and in order to increase battery usage time in mobile devices, coil electronic components with low loss and excellent efficiency are employed around a power management integrated circuit (PMIC). On the other hand, there is a growing demand for a thin power inductor in order to slim products and increase the degree of freedom in component arrangement.

### SUMMARY

The present disclosure attempts to provide a coil electronic component having a thin thickness without volumetric loss of a magnetic body.

However, the objective of the present disclosure is not limited to the aforementioned one, and may be extended in various ways within the spirit and scope of the present disclosure.

A coil electronic component according to one aspect of the present disclosure may include a magnetic body having a first surface and a second surface facing each other in a first direction, a third surface and a fourth surface facing each other in a second direction and connecting the first surface and the second surface, and a fifth surface and a sixth surface facing each other in a third direction and connecting the first surface and the second surface, a coil of which at least a portion is embedded in the magnetic body, a first external electrode disposed on the sixth surface of the magnetic body and extending onto a portion of the first surface and connected to the coil, a second external electrode disposed on the sixth surface of the magnetic body and extending onto a portion of the second surface and connected to the coil, a first insulation layer covering the first external electrode on the first surface of the magnetic body, and a second insulation layer covering the second external electrode on the second surface of the magnetic body.

A coil electronic component may further include a third insulation layer surrounding edges of the first external electrode on the first surface of the magnetic body facing the third surface, the fourth surface and the fifth surface, and a fourth insulation layer surrounding edges of the second external electrode on the second surface of the magnetic body facing the third surface, the fourth surface and the fifth surface.

The first insulation layer may cover at least a portion of the third insulation layer and, the second insulation layer may cover at least a portion of the fourth insulation layer.

The first external electrode may include a first electrode pad disposed on the sixth surface of the magnetic body and a first connection portion disposed on the first surface of the magnetic body, and the second external electrode may include a second electrode pad disposed on the sixth surface of the magnetic body and a second connection portion disposed on the second surface of the magnetic body.

The first electrode pad and the first connection portion may be an integral structure, and the second electrode pad and the second connection portion may be an integral structure.

The first connection portion may be spaced apart from the fifth surface of the magnetic body, and the second connection portion may be spaced apart from the fifth surface of the magnetic body.

The first connection portion may be spaced apart from each of the third surface and the fourth surface of the magnetic body, and the second connection portion may be spaced apart from each of the third surface and the fourth surface of the magnetic body.

The coil may be a wound coil.

The coil electronic component may further include a support member disposed within the magnetic body, and including a first support surface and a second support surface facing each other, where the coil may include a first coil pattern disposed on the first support surface of the support member, a second coil pattern disposed on the second support surface of the support member, and a via connecting the first coil pattern and the second coil pattern.

The magnetic body may be a stack of a plurality of sheets, and the coil may include a plurality of coil patterns disposed on respective sheets of the plurality of sheets and connected to each other.

The coil electronic component may further include a fifth insulation layer disposed between the first external electrode and the second external electrode on the sixth surface of the magnetic body.

The fifth insulation layer may be also disposed on the third surface, the fourth surface, and the fifth surface of the magnetic body.

A coil electronic component according to another aspect of the present disclosure may include a magnetic body having a first surface and a second surface facing each other in a first direction, a third surface and a fourth surface facing each other in a second direction and connecting the first surface and the second surface, and a fifth surface and a sixth surface facing each other in a third direction and connecting the first surface and the second surface, the first and second surfaces including a first recess portion and a second recess portion, respectively, that are spaced apart from the fifth surface of the magnetic body, a coil of which at least a portion is embedded in the magnetic body, a first external electrode including a first electrode pad disposed on the sixth surface of the magnetic body and a first connection portion embedded in the first recess portion and connected to the coil, and a second external electrode including a second electrode pad disposed on the sixth surface of the magnetic body and a second connection portion embedded in the second recess portion and connected to the coil.

Each of the first and second recess portions may be spaced apart from the third surface and the fourth surface of the magnetic body such that the first and second connection portions are spaced apart from the third surface and the fourth surface of the magnetic body.

The coil electronic component may further include a first insulation layer covering the first connection portion embedded in the first recess portion, and a second insulation layer covering the second connection portion embedded in the second recess portion.

The coil electronic component may further include a third insulation layer surrounding edges of the first connection portion facing the third surface, the fourth surface and the fifth surface of the magnetic body, and a fourth insulation layer surrounding edges of the second connection portion facing the third surface, the fourth surface and the fifth surface of the magnetic body.

The coil electronic component may further include a fifth insulation layer disposed between the first electrode pad and the second electrode pad on the sixth surface of the magnetic body.

The coil electronic component may further include at least one plating layer disposed on the first electrode pad and the second electrode pad, in which an outer surface of the at least one plating layer protrudes from an outer surface of the fifth insulation layer in the third direction.

The first and second insulation layers may further extend from outer surfaces of the first and second electrode pads in the third direction, and a side surface of the at least one plating layer may abut onto a side surface of the first insulation layer or the second insulation layer in the first direction.

According to an embodiment, a coil electronic component having a thin thickness without volumetric loss of a magnetic body thickness may be provided.

### BRIEF DESCRIPTION OF THE DRAWINGS

FIG. 1 a perspective view schematically showing a coil electronic component according to an embodiment.

FIG. 2 is a schematic cross-sectional view taken along line II-II′ of FIG. 1.

FIG. 3 a side view schematically showing the coil electronic component of FIG. 1.

FIG. 4A, FIG. 4B, FIG. 4C, FIG. 4D, FIG. 4E and FIG. 4F are drawings showing example steps of forming an external electrode on the coil electronic component of FIG. 1.

FIG. 5 a cross-sectional view schematically showing a coil electronic component according to a Comparative Example.

FIG. 6 a perspective view schematically showing a coil electronic component according to another embodiment.

FIG. 7 is a schematic cross-sectional view taken along line VII-VII′ of FIG. 6.

FIG. 8 a partial cross-sectional view schematically showing a coil electronic component according to yet another embodiment.

### DETAILED DESCRIPTION OF THE EMBODIMENTS

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. In addition, some constituent elements are exaggerated, omitted, or briefly illustrated in the accompanying drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various constituent elements, and are not to be interpreted as limiting these constituent elements. The terms are only used to differentiate one constituent element from other constituent elements.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

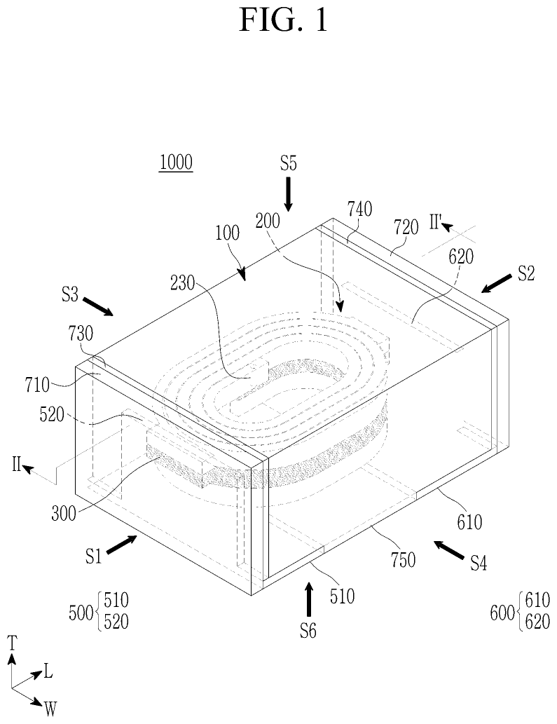

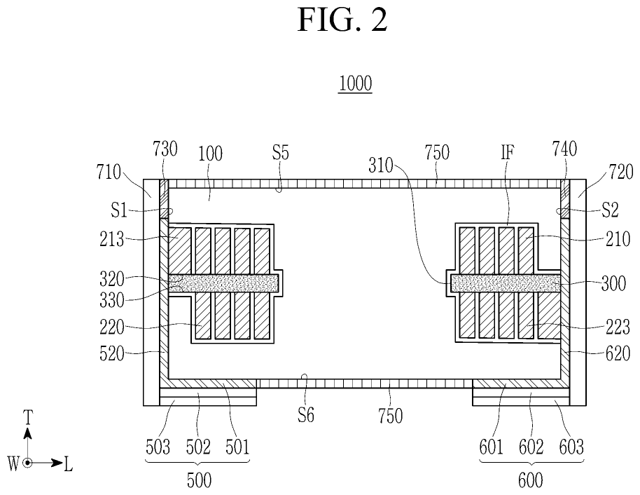

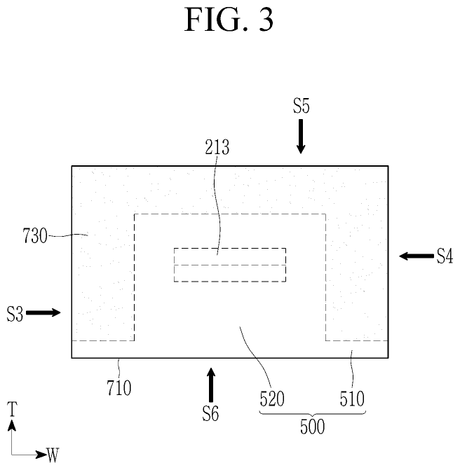

FIG. 1 a perspective view schematically showing a coil electronic component according to an embodiment. FIG. 2 is a schematic cross-sectional view taken along line II-II′ of FIG. 1. FIG. 3 a side view schematically showing the coil electronic component of FIG. 1.

Referring to FIG. 1, FIG. 2, and FIG. 3, a coil electronic component 1000 according to an embodiment includes a main body 100, a coil 200, a support member 300, a first external electrode 500, a second external electrode 600, a first insulation layer 710, a second insulation layer 720, a third insulation layer 730, a fourth insulation layer 740 and a fifth insulation layer 750.

The main body 100 may have a substantially rectangular parallelepiped shape, but the present embodiment is not limited thereto. Due to shrinkage during sintering, the main body 100 may have a substantially rectangular parallelepiped shape, although not a perfect rectangular parallelepiped shape. For example, the main body 100 has a substantially rectangular parallelepiped shape, but corner or vertex portions may have a round shape.

In the present embodiment, for convenience of description, two surfaces facing each other in a length direction (L-axis direction) are defined as a first surface S1 and a second surface S2, respectively, two surfaces facing each other in a width direction (W-axis direction) are defined as a third surface S3 and a fourth surface S4, respectively, and two surfaces facing each other in a thickness direction (T-axis direction) are defined as a fifth surface S5 and a sixth surface S6, respectively.

A length of the coil electronic component 1000 may mean, based on an optical microscope or scanning electron microscope (SEM) photograph of a cross-section taken in the length direction (L-axis direction)−the thickness direction (T-axis direction) at a center of the coil electronic component 1000 in the width direction (W-axis direction), a maximum value of lengths of a plurality of line segments that connect two outermost boundary lines facing each other in the length direction (L-axis direction) of the coil electronic component 1000 shown in the above cross-sectional photograph and are parallel to the length direction (L-axis direction). Alternatively, the length of the coil electronic component 1000 may mean a minimum value of lengths of a plurality of line segments that connect two outermost boundary lines facing each other in the length direction (L-axis direction) of the coil electronic component 1000 shown in the above-mentioned cross-section photograph and are parallel to the length direction (L-axis direction), respectively. Alternatively, the length of the coil electronic component 1000 may mean an arithmetic mean value of lengths of at least two of a plurality of line segments that connect two outermost boundary lines facing each other in the length direction (L-axis direction) of the coil electronic component 1000 shown in the above cross-sectional photograph and are parallel to the length direction (L-axis direction).

A thickness of the coil electronic component 1000 may mean, based on an optical microscope or scanning electron microscope (SEM) photograph of a cross-section taken in the length direction (L-axis direction)−the thickness direction (T-axis direction) at a center of the coil electronic component 1000 in the width direction (W-axis direction), a maximum value of lengths of a plurality of line segments that connect two outermost boundary lines facing each other in the thickness direction (T-axis direction) of the coil electronic component 1000 shown in the above cross-sectional photograph and are parallel to the thickness direction (T-axis direction). Alternatively, the thickness of the coil electronic component 1000 may mean a minimum value of lengths of a plurality of line segments that connect two outermost boundary lines facing each other in the thickness direction (T-axis direction) of the coil electronic component 1000 shown in the above-mentioned cross-section photograph and are parallel to the thickness direction (T-axis direction), respectively. Alternatively, the thickness of the coil electronic component 1000 may mean an arithmetic mean value of lengths of at least two line segments among a plurality of line segments that connect two outermost boundary lines facing each other in the thickness direction (T-axis direction) of the coil electronic component 1000 shown in the above-mentioned cross-section photograph and parallel to the thickness direction (T-axis direction), respectively.

A width of the coil electronic component 1000 may mean, based on an optical microscope or scanning electron microscope (SEM) photograph of a cross-section taken in the length direction (L-axis direction)−the width direction (W-axis direction) at a center of the coil electronic component 1000 in the thickness direction (T-axis direction), a maximum value of lengths of a plurality of line segments that connect two outermost boundary lines facing each other in the width direction (W-axis direction) of the coil electronic component 1000 shown in the above cross-sectional photograph and are parallel to the width direction (W-axis direction). Alternatively, the width of the coil electronic component 1000 may mean a minimum value of lengths a plurality of line segments that connect two outermost boundary lines facing each other in the width direction (W-axis direction) of the coil electronic component 1000 shown in the above-mentioned cross-section photograph and are parallel to the width direction (W-axis direction), respectively. On the other hand, the width of the coil electronic component 1000 may mean an arithmetic mean value of lengths of at least two line segments among a plurality of line segments that connect two outermost boundary lines facing each other in the width direction (W-axis direction) of the coil electronic component 1000 shown in the above-mentioned cross-section photograph and are parallel to the width direction (W-axis direction), respectively.

Meanwhile, each of the length, width, and thickness of the coil electronic component 1000 may be measured using a micrometer measurement method. The micrometer measurement method may be performed by setting a zero point by using a micrometer with Gage R&R (repeatability and reproducibility), inserting the coil electronic component 1000 according to the present embodiment between tips of the micrometer, and rotating a measurement lever of the micrometer. Meanwhile, when measuring the length of the coil electronic component 1000 by using the micrometer measurement method, the length of the coil electronic component 1000 may mean a value measured once or mean an arithmetic mean of values measured multiple times. The same may also apply to the measurement of the width and the thickness of the coil electronic component 1000.

The main body 100 constitutes an exterior of the coil electronic component 1000, and is a space where a magnetic path, which is a path through which the magnetic flux induced by the coil 200 passes, is formed, when a current is applied to the coil 200 through the first external electrode 500 and the second external electrode and 600.

The main body 100 surrounds and encapsulates the coil 200 and the support member 300, and includes a magnetic material. The main body 100 includes magnetic particles, and an insulation material may be interposed between the magnetic particles.

The magnetic material may include a first metal magnetic powder, a second metal magnetic powder having a larger particle size than the first magnetic powder, and a third metal magnetic powder having a larger particle size than the second magnetic powder. The average particle diameter D₅₀ of the first metal magnetic powder may be 0.1 μm or more and 0.2 μm or less, the particle diameter D₅₀ of the second metal magnetic powder may be 1 μm or more and 2 μm or less, and the particle diameter D₅₀ the third metal magnetic powder may be 25 μm or more and 30 μm or less.

The magnetic particles may be ferrite particles or metal magnetic particles exhibiting magnetic properties.

The ferrite particles may include, for example, at least one of Mg—Zn-based, Mn—Zn-based, Mn—Mg-based, Cu—Zn-based, Mg—Mn—Sr-based, Ni—Zn-based spinel ferrite magnetic particles, Ba—Zn-based, Ba—Mg-based, Ba—Ni-based, Ba—Co-based, Ba—Ni—Co-based hexagonal ferrite magnetic particles, Y-based garnet-type ferrite magnetic particles and Li-based ferrite magnetic particles.

The metal magnetic particles may comprise two or more types of powders having different compositions, and may include at least one selected from the group consisting of iron (Fe), silicon (Si), chromium (Cr), cobalt (Co), molybdenum (Mo), aluminum (AI), niobium (Nb), copper (Cu), and nickel (Ni). For example, metal magnetic particles may be at least one of pure iron, Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, Fe—Cr—Al-based alloy. Here, different compositions of metal magnetic particles may mean different contents.

The metal magnetic particles may be amorphous or crystalline. For example, the metal magnetic particles may be an Fe—Si—B—Cr-based amorphous alloy, but the present embodiment is not limited thereto. The metal magnetic particles may have an average particle diameter of about 0.1 μm to about 30 μm, but are not limited thereto. In this specification, the average particle diameter may mean a particle size distribution expressed by D₉₀, D₅₀, or the like. The particle size distribution is well known to those skilled in the art as an indicator of what proportion of particles of what size (particle diameter) are contained within a population of particles to be measured. D₅₀ (a particle diameter corresponding to 50% of a cumulative volume of the particle size distribution) refers to an average particle diameter.

The metal magnetic particles may be two or more types of different metal magnetic particles. Here, that the types of the metal magnetic particles are different means that the metal magnetic particles are distinguished from each other in at least one of an average diameter, composition, component ratio, crystallinity, and shape.

The insulating resin may include epoxy, polyimide, liquid crystal polymer, etc. alone or in combination, but is not limited thereto.

A method of forming the main body 100 is not particularly limited. For example, the main body 100 may be formed by placing sheets of magnetic material on the upper and lower portions of the coil 200 and then compressing and curing the sheets.

The support member 300 is disposed inside the main body 100 and supports the coil 200.

The support member 300 may be made of an insulation material that includes a thermosetting insulation resin such as epoxy resin, a thermoplastic insulation resin such as polyimide, or a photosensitive insulation resin, or may be made of an insulation material formed by impregnating a reinforcing material such as glass fiber or inorganic filler in the above-described insulation resin. For example, the support member 300 may be made of an insulation material such as pre-preg, ABF (Ajinomoto Build-up Film), FR-4, BT (Bismaleimide Triazine) film, PID (Photo Imageable Dielectric) film, or the like, however, the present embodiment is not limited thereto.

At least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AIBO₃), barium titanate (BaTiO₃) and calcium zirconate (CaZrO₃) may be used as the inorganic filler.

A through-hole 310 is at a center of the support member 300. The through-hole 310 may be filled with the magnetic material that comprises the main body 100 to form a core, thereby improving the performance of the coil electronic component.

The coil 200 is embedded in the main body 100, exhibiting the characteristics of the coil electronic component 1000. For example, when the coil electronic component 1000 of the present embodiment is used as a power inductor, when a current is applied to the coil 200, the coil 200 may serve to stabilize the power source of an electronic device by maintaining an output voltage by storing an electric field as a magnetic field.

The coil 200 may be disposed on a first support surface 320 and a second support surface 330 of the support member 300, which are opposite to each other. The coil 200 may include a first coil pattern 210 and a second coil pattern 220, the first coil pattern 210 and the second coil pattern 220 may be electrically connected to each other through a via 230.

The first coil pattern 210 is disposed on the first support surface 320 of the support member 300 and includes a first lead-out portion 213. The first lead-out portion 213 is exposed from the first surface S1 of the main body 100 and electrically connected to the first external electrode 500.

The second coil pattern 220 is disposed on the second support surface 330 of the support member 300 and includes a second lead-out portion 223. The second lead-out portion 223 is exposed from the second surface S2 of the main body 100 and electrically connected to the second external electrode 600.

Meanwhile, when the first coil pattern 210, the first lead-out portion 213, and the via 230 are formed by plating on the first support surface 320 of the support member 300, the first coil pattern 210, the first lead-out portion 213, and the via 230 may include a seed layer such as an electroless plating layer and an electroplating layer, respectively. Here, the electroplating layer may have a single-layer structure or a multi-layer structure. The electroplating layer of the multi-layer structure may be formed as a conformal film structure in which one electroplating layer is covered by the other electroplating layer, or as a stacked structure in which one electroplating layer is stacked on only one surface of the other electroplating layer. The seed layer of the first coil pattern 210, the seed layer of the first lead-out portion 213, and the seed layer of the via 230 may be integrally formed without a boundary therebetween, but the present embodiment is not limited thereto. The electroplating layer of the first coil pattern 210, the electroplating layer of the first lead-out portion 213, and the electroplating layer of the via 230 may be integrally formed without a boundary therebetween, but the present embodiment is not limited thereto. The above description may equally apply to the second coil pattern 220, the second lead-out portion 223, and the via 230.

Each of the coil 200 and the via 230 may be made of a conductive material such as, copper (Cu), aluminum (AI), silver (Ag), tin (Sn), gold (Au), nickel (Ni), lead (Pb), titanium (Ti), an alloy thereof, or the like, but the present embodiment is not limited thereto.

An insulation layer IF may be disposed between the coil 200 and the main body 100. The insulation layer IF may be disposed along a surface of the support member 300 and the coil 200. The insulation layer IF does not exist in a portion where the support member 300 and the coil 200 are connected to the external electrodes 500 and 600. The insulation layer IF is for insulating the coil 200 from the main body 100 and may include a known insulating material such as parylene. Any insulating material may be used in the insulation layer IF, and there is no particular limitation. For example, the insulation layer IF may be a polyurethane resin, a polyester resin, an epoxy resin, or a polyamideimide resin. The insulation layer IF may be formed by a method such as vapor deposition, but is not limited thereto. For example, the insulation layer IF may be formed by stacking insulating films on both sides of the support member 300.

The first external electrode 500 and the second external electrode 600 are disposed outside the main body 100 and are connected to the coil 200. That is, the first external electrode 500 and the second external electrode 600 are respectively connected to the first lead-out portion 213 and the second lead-out portion 223 of the coil 200.

The first external electrode 500 extends from the sixth surface S6 of the main body 100 to a portion of the first surface S1, and is connected to the first lead-out portion 213 of the coil 200.

For example, the first external electrode 500 may include a first electrode pad 510 and a first connection portion 520.

The first electrode pad 510 is disposed on the sixth surface S6 of the main body 100, and the first connection portion 520 extends from the first electrode pad 510 to the first surface S1 of the main body 100. The first lead-out portion 213 of the coil 200 is exposed from the first surface S1 of the main body 100, and is connected to the first connection portion 520. Accordingly, the coil 200 is electrically connected to the first external electrode 500.

The first electrode pad 510 and the first connection portion 520 may be an integral structure. For example, the first electrode pad 510 and the first connection portion 520 may be formed by plating.

The second external electrode 600 extends from the sixth surface S6 of the main body 100 to a portion of the second surface S2, and is connected to the second lead-out portion 223 of the coil 200.

For example, the second external electrode 600 may include a second electrode pad 610 and a second connection portion 620.

The second electrode pad 610 is disposed on the sixth surface S6 of the main body 100, and the second connection portion 620 extends from the second electrode pad 610 to the second surface S2 of the main body 100. The second lead-out portion 223 of the coil 200 is exposed from the second surface S2 of the main body 100, and is connected to the second connection portion 620. Accordingly, the coil 200 is electrically connected to the second external electrode 600.

The second electrode pad 610 and the second connection portion 620 may be an integral structure. For example, the second electrode pad 610 and the second connection portion 620 may be formed by plating.

The first external electrode 500 may include a first metal layer 501, a second metal layer 502, and a third metal layer 503.

The first metal layer 501 is a plating layer that is in contact with the first lead-out portion 213 of the coil 200 and outer surfaces of the main body 100, that is, the first surface S1 and the sixth surface S6, and may include copper (Cu). The first metal layer 501 may comprise the first electrode pad 510 and the first connection portion 520 of the first external electrode 500.

The second metal layer 502 is a plating layer that covers the first metal layer 501 and may include nickel (Ni). The second metal layer 502 may be disposed on the first electrode pad 510 and may not be disposed on the first connection portion 520.

The third metal layer 503 is a plating layer that covers the second metal layer 502 and may include tin (Sn). The third metal layer 503 may be disposed on the first electrode pad 510 and may not be disposed on the first connection portion 520.

However, the present embodiment is not limited to the above-described three-layer structure, and a two-layer structure in which only one plating layer is added on the first metal layer 501 is also possible.

The second external electrode 600 may include a first metal layer 601, a second metal layer 602, and a third metal layer 603.

The first metal layer 601 is a plating layer that is in contact with the second lead-out portion 223 of the coil 200 and outer surfaces of the main body 100, that is, the second surface S2 and the sixth surface S6, and may include copper (Cu). The first metal layer 601 may comprise the second electrode pad 610 and the second connection portion 620 of the second external electrode 600.

The second metal layer 602 is a plating layer that covers the first metal layer 601 and may include nickel (Ni). The second metal layer 602 may be disposed on the second electrode pad 610 and may not be disposed on the second connection portion 620.

The third metal layer 603 is a plating layer that covers the second metal layer 602 and may include tin (Sn). The third metal layer 603 may be disposed on the second electrode pad 610 and may not be disposed on the second connection portion 620.

However, the present embodiment is not limited to the above-described three-layer structure, and a two-layer structure in which only one plating layer is added on the first metal layer 601 is also possible.

As described above, the first external electrode 500 and the second external electrode 600 may each include nickel (Ni), copper (Cu), palladium (Pd), gold (Au), or an alloy thereof, and may each include a plurality of plating layers. For example, the first external electrode 500 and the second external electrode 600 may each comprise a combination of nickel (Ni) layer, copper (Cu) layer, nickel/copper (Ni/Cu) layer, palladium/nickel (Pd/Ni) layer, palladium/nickel/copper (Pd/Ni/Cu) layer, or copper/nickel/copper (Cu/Ni/Cu) layer.

In some embodiments, an outermost layer may be made of tin (Sn). Since the tin plating layer has a relatively low melting point, it is possible to improve the mountability of the first external electrode 500 and the second external electrode 600 on a substrate.

In general, the tin plating layer may be connected to an electrode pad on a substrate via a solder that includes a tin (Sn)-copper (Cu)-silver (Ag) alloy paste. That is, the tin plating layer and the solder may melt and bond to each other during a reflow process.

The first insulation layer 710 covers the first external electrode 500 on the first surface S1 of the main body 100. The second insulation layer 720 covers the second external electrode 600 on the second surface S2 of the main body 100.

The third insulation layer 730 surrounds edges toward the third surface S3, the fourth surface S4, and the fifth surface S5 of the first external electrode 500 on the first surface S1 of the main body 100. For example, in three regions between the first connection portion 520 and the third surface S3, the fourth surface S4, and the fifth surface S5 of the main body 100, the third insulation layer 730 contacts the first connection portion 520 and covers the first surface S1 of the main body 100.

The first insulation layer 710 covers the first external electrode 500 on the first surface S1 of the main body 100, and therefore the first insulation layer 710 may cover the first connection portion 520. The first insulation layer 710 may also cover the third insulation layer 730 that surrounds the edges of the first connection portion 520. That is, the first insulation layer 710 may cover the first connection portion 520 and the third insulation layer 730.

The fourth insulation layer 740 surrounds edges toward the third surface S3, the fourth surface S4, and the fifth surface S5 of the second external electrode 600 on the second surface S2 of the main body 100. For example, in three regions between the second connection portion 620 and the third surface S3, the fourth surface S4, and the fifth surface S5 of the main body 100, the fourth insulation layer 740 contacts the second connection portion 620 and covers the second surface S2 of the main body 100.

The second insulation layer 720 covers the second external electrode 600 on the second surface S2 of the main body 100, and therefore the second insulation layer 720 may cover the second connection portion 620. The second insulation layer 720 may also cover the fourth insulation layer 740 that surrounds the edges of the second connection portion 620. That is, the second insulation layer 720 may cover the second connection portion 620 and the fourth insulation layer 740.

The fifth insulation layer 750 may be disposed in a region where the first external electrode 500 and the second external electrode 600 are not disposed on the sixth surface S6 of the main body 100. That is, the fifth insulation layer 750 may be disposed in a region excluding the first electrode pad 510 and the second electrode pad 610 on the sixth surface S6 of the main body 100. The fifth insulation layer 750 may also be disposed on at least a portion of the third surface S3, the fourth surface S4, and the fifth surface S5 of the main body 100. The fifth insulation layer 750 may prevent an electrical short between other electronic components and the external electrodes 500 and 600.

In the above, the first insulation layer 710, the second insulation layer 720, the third insulation layer 730, the fourth insulation layer 740 and the fifth insulation layer 750 were described, and they may not be formed in the listed sequence. In addition, these insulation layers may be made of the same material or may be made of different materials.

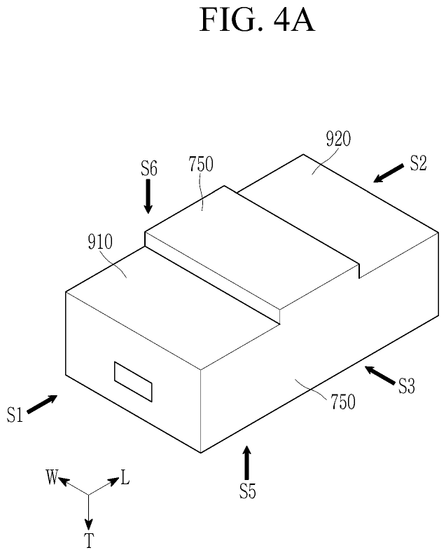

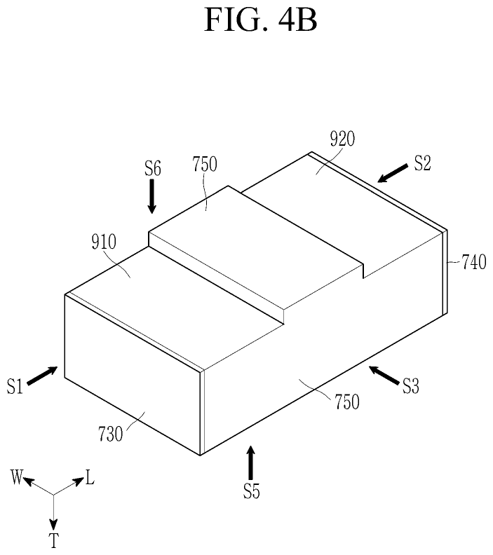

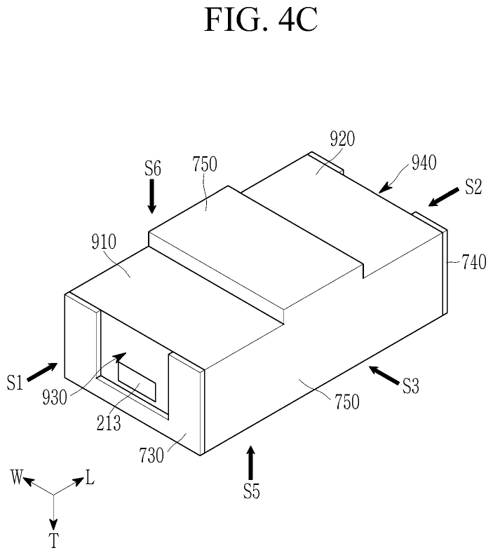

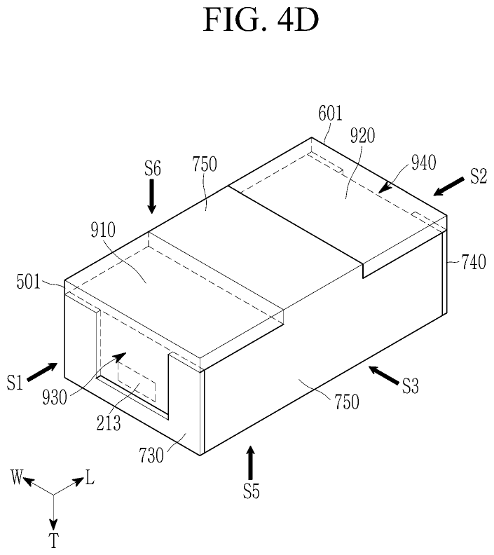

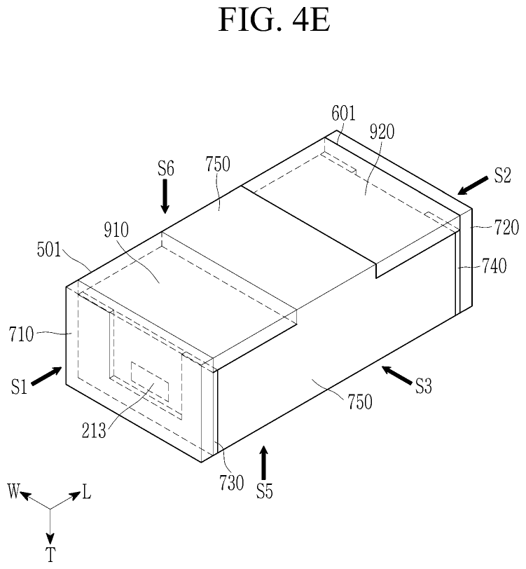

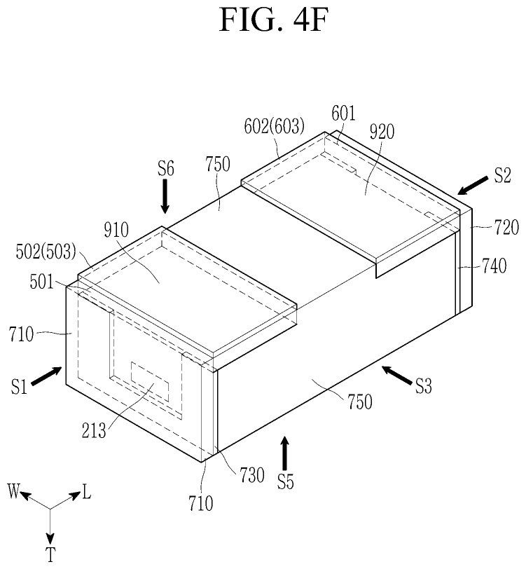

FIG. 4A, FIG. 4B, FIG. 4C, FIG. 4D, FIG. 4E and FIG. 4F are drawings showing example steps of forming an external electrode on the coil electronic component of FIG. 1. Since structures and materials of the first external electrode 500 and the second external electrode 600 correspond to each other, hereinafter, the first external electrode 500 will be mainly described.

Referring to FIG. 4A, portions of the fifth insulation layer 750 on the sixth surface S6 of the main body 100 are removed to form a first pad region 910 and a second pad region 920. A method of removing the fifth insulation layer 750 may include a grinding process, but is not limited thereto.

The first pad region 910 and the second pad region 920 are spaced apart from each other in the length direction (L-axis direction). That is, the fifth insulation layer 750 remains between the first pad region 910 and the second pad region 920. A first electrode pad 510 is later disposed in the first pad region 910, and a second electrode pad 610 is later disposed in the second pad region 920.

Portions of the fifth insulation layer 750 are also removed from the first surface S1 of the main body 100 on which the first connection portion 520 is to be disposed and from the second surface S2 of the main body 100 on which the second connection portion 620 is to be disposed.

Referring to FIG. 4B, the third insulation layer 730 is disposed on the first surface S1 of the main body 100 on which the first connection portion 520 is to be disposed, and the fourth insulation layer 740 is disposed on the second surface S2 of the main body 100 on which the second connection portion 620 is to be disposed.

Referring to FIG. 4C, a portion of the third insulation layer 730 is removed from the first surface S1 of the main body 100 to expose the first lead-out portion 213 of the coil 200 and a portion of the fourth insulation layer 740 is removed from the second surface S2 to expose the second lead-out portion 223 of the coil 200. In this case, by using laser, the third insulation layer 730 may be etched on the first surface S1 of the main body 100 to form a first recess portion 930, and the fourth insulation layer 740 may be etched on the second surface S2 to form a second recess portion 940. However, the method of removing the third insulation layer is not limited thereto. The first recess portion 930 may have a shape in which a portion of the third insulation layer 730 is depressed to expose the first surface S1 of the main body 100, and the second recess portion 940 may have a shape in which a portion of the fourth insulation layer 740 is depressed to expose the second surface S2 of the main body 100. In other words, the first recess portion 930 may be a region surrounded by the third insulation layer 730 like a wall, and the second recess portion 940 may be a region surrounded by the fourth insulation layer 740 like a wall. That is, in the length direction (L-axis direction), the third insulation layer 730 protrudes more than the first recess portion 930, and the fourth insulation layer 740 protrudes more than the second recess portion 940. However, a side of the first recess portion 930 toward the sixth surface S6 may be in an open shape, and a side of the second recess portion 940 toward the sixth surface S6 may be in an open shape.

Referring to FIG. 4D, plating is performed on the first pad region 910 and the first recess portion 930 to form the first metal layer 501 that spans the first pad region 910 and the first recess portion 930, and plating is performed on the second pad region 920 and the second recess portion 940 to form the first metal layer 601 that spans the second pad region 920 and the second recess portion 940.

Except for a side of the main body 100 toward the sixth surface S6, the first recess portion 930 is surrounded by the third insulation layer 730. Particularly, since the third insulation layer 730 is also disposed between the first recess portion 930 and the fifth surface S5 of the main body 100, spreading of plating to the fifth surface S5 may be prevented. That is, in the length direction (L-axis direction), since the third insulation layer 730 protrudes more than the first recess portion 930, the third insulation layer 730 may function as a wall that blocks the growth of the plating toward the fifth surface S5 of the main body 100. As a result, except for a side of the main body 100 toward the sixth surface S6, the first metal layer 501 is surrounded by the third insulation layer 730.

Referring to FIG. 4E, the first insulation layer 710 is formed to cover the first metal layer 501. The first insulation layer 710 may cover both the first metal layer 501 and the third insulation layer 730. The first metal layer 501 on the sixth surface S6 in the first pad region 910 is not covered by the first insulation layer 710. Similarly, the first metal layer 601 on the sixth surface S6 in the second pad region 920 is not covered by the second insulation layer 720.

Referring to FIG. 4F, additional plating is performed to cover the first metal layer 501 in the first pad region 910 and the first metal layer 601 in the second pad region 920. Accordingly, the second metal layers 502 and 602 and the third metal layers 503 and 603 may be formed.

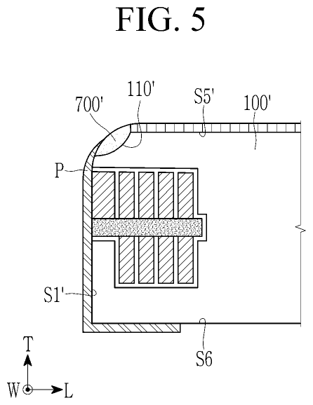

FIG. 5 is a cross-sectional view schematically showing a coil electronic component according to a Comparative Example.

Referring to FIG. 5, a coil electronic component according to a Comparative Example includes a slit 110′, which is formed by partially removing an edge of the first surface S1′ toward the fifth surface S5′ of a main body 100′, and an insulation layer 700′ disposed in the slit 110′. In this case, since the insulation layer 700′ formed in the slit 110′ does not protrude from the first surface S1′ of the main body 100′, the effect of preventing the spreading of plating P toward the fifth surface S5′ may not be significant. In this case, since a portion of the main body 100′ is removed to form the slit 110′, the volume of the main body 100′ is reduced by that amount. As a result, adverse effects may occur on the characteristics of coil electronic components.

On the other hand, according to the present embodiment, since the third insulation layer 730 may function as a wall, spreading of plating to the fifth surface S5 of the main body 100 may be effectively blocked, and since the main body 100 need not be removed in order to prevent the spreading of plating, the characteristics of the coil electronic component may be enhanced.

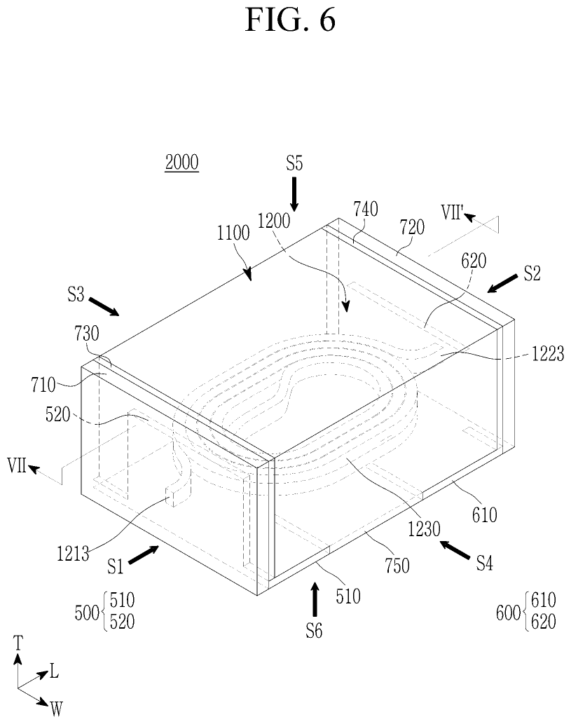

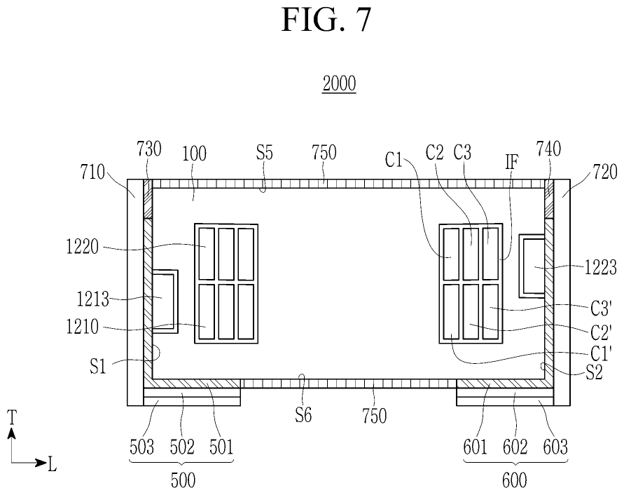

FIG. 6 is a perspective view schematically showing a coil electronic component according to another embodiment. FIG. 7 is a schematic cross-sectional view taken along line VII-VII′ of FIG. 6.

Referring to FIG. 6 and FIG. 7, a coil electronic component 2000 includes a main body 1100, a coil 1200, a first external electrode 500, a second external electrode 600, a first insulation layer 710, a second insulation layer 720, a third insulation layer 730, a fourth insulation layer 740 and a fifth insulation layer 750.

The coil 1200 may include at least one turn of a conductive wire. For example, the coil 1200 may be in the form of a spirally wound metal (e.g., copper (Cu) or silver (Ag)) wire with a surface coated with an insulating material. That is, the coil 1200 may be a wound coil. The coil 1200 is not limited to a single wire, and may comprise a twisted wire or two or more wires.

The coil 1200 may be a circular coil but is not limited thereto. For example, the coil 1200 may be a variety of well-known coils such as a rectangular coil.

Cross-sections of individual wires of the coil 1200 may have various well-known shapes such as a square, a circle, a triangle, and an ellipse.

The coil 1200 may comprise a plurality of layers. The coil 1200 may include a first coil 1210 and a second coil 1220. The second coil 1220 may be connected to the first coil 1210 and be disposed above the first coil 1210, that is, on a side toward the fifth surface S5 of the main body 1100, comprising a layer.

The number of turns of the first coil 1210 and the number of turns of the second coil 1220 may be the same or different.

The coil 1200 may have a planar spiral shape and may have a plurality of turns. That is, the second coil 1220 may sequentially include an innermost turn coil C1, at least one intermediate turn coil C2, and an outermost turn coil C3, in a direction from a central point of the main body 1100 in a length direction (L-axis direction) to the first surface S1. The first coil 1210 may also sequentially include an innermost turn coil C1′, at least one intermediate turn coil C2′, and an outermost turn coil C3′, in the direction from the central point of of the main body 1100 in the length direction (L-axis direction) to the second surface S2.

An insulation layer IF may be disposed along a surface of each of the plurality of turns of the coil 1200. The insulation layer IF is for protecting and insulating the plurality of turns of the first coil 1210 and the second coil 1220, and may include a known insulating material such as parylene. Any insulating material may be used in the insulation layer IF, and there is no particular limitation. For example, the insulation layer IF may be a polyurethane resin, a polyester resin, an epoxy resin, or a polyamideimide resin. The insulation layer IF may be formed by a method such as vapor deposition, but is not limited thereto.

The coil 1200 may include a wound portion 1230, a first lead-out portion 1213 and a second lead-out portion 1223.

The wound portion 1230 is a portion where a metal wire forms at least one turn.

The first lead-out portion 1213 extends from one end of the wound portion 1230 and is exposed from the first surface S1 of the main body 1100. The first lead-out portion 1213 is connected to the first external electrode 500. The second lead-out portion 1223 extends from the other end of the wound portion 1230 and is exposed from the second surface S2 of the main body 1100. The second lead-out portion 1223 is connected to the second external electrode 600.

Components except for the above-described components are the same as those of the coil electronic component shown in FIG. 1, so redundant descriptions thereof will be omitted.

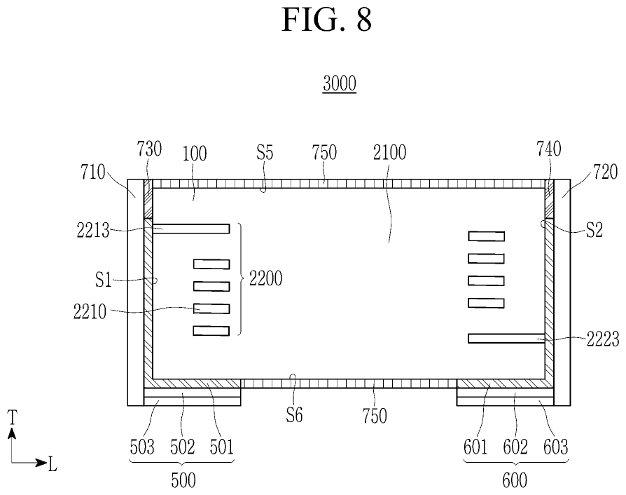

FIG. 8 is a partial cross-sectional view schematically showing a coil electronic component according to yet another embodiment.

Referring to FIG. 8, a coil electronic component 3000 includes a main body 2100, a coil 2200, a first external electrode 500, a second external electrode 600, a first insulation layer 710, a second insulation layer 720, a third insulation layer 730, a fourth insulation layer 740 and a fifth insulation layer 750.

The main body 2100 may be a stack of a plurality of sheets comprising magnetic material stacked in the thickness direction (T-axis direction). The coil 2200 may include a plurality of coil patterns 2210 disposed on respective sheets and connected to each other.

A first lead-out portion 2213 is provided at one end of the coil 2200, and a second lead-out portion 2223 is provided at the other end thereof. The first lead-out portion 2213 is exposed from the first surface S1 of the main body 2100 and connected to the first external electrode 500. The second lead-out portion 2223 is exposed from the second surface S2 of the main body 2100 and connected to the second external electrode 600.

Other components except for the above are the same as those of the coil electronic component shown in FIG. 1, and therefore, redundant description thereof will be omitted.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

1000, 2000, 3000: coil electronic component
100, 1100, 2100: main body
200, 1200, 2200: coil
210: first coil pattern
220: second coil pattern
230: via
213, 1213, 2213: first lead-out portion
223, 1223, 2223: second lead-out portion
300: support member
500: first external electrode
501, 601: first metal layer
502, 602: second metal layer
503, 603: third metal layer
510: first electrode pad
520: first connection portion
600: second external electrode
610: second electrode pad
620: second connection portion
710: first insulation layer
720: second insulation layer
730: third insulation layer
740: fourth insulation layer
750: fifth insulation layer
910: first pad region
920: second pad region
930: first recess portion
940: second recess portion
1210: first coil
1220: second coil
1230: wound portion
2210: coil pattern
IF: insulation layer

What is claimed is:

1. A coil electronic component, comprising:
a magnetic body comprising a first surface and a second surface facing each other in a first direction, a third surface and a fourth surface facing each other in a second direction and connecting the first surface and the second surface, and a fifth surface and a sixth surface facing each other in a third direction and connecting the first surface and the second surface;
a coil of which at least a portion is embedded in the magnetic body;
a first external electrode disposed on the sixth surface of the magnetic body and extending onto a portion of the first surface to be connected to the coil;
a second external electrode disposed on the sixth surface of the magnetic body and extending onto a portion of the second surface to be connected to the coil;
a first insulation layer covering the first external electrode on the first surface of the magnetic body; and
a second insulation layer covering the second external electrode on the second surface of the magnetic body.

2. The coil electronic component of claim 1, further comprising:
a third insulation layer surrounding edges of the first external electrode on the first surface of the magnetic body, the edges facing the third surface, the fourth surface and the fifth surface of the magnetic body; and
a fourth insulation layer surrounding edges of the second external electrode on the second surface of the magnetic body, the edges facing the third surface, the fourth surface and the fifth surface of the magnetic body.

3. The coil electronic component of claim 2, wherein:
the first insulation layer covers at least a portion of the third insulation layer; and
the second insulation layer covers at least a portion of the fourth insulation layer.

4. The coil electronic component of claim 1, wherein:
the first external electrode comprises a first electrode pad disposed on the sixth surface of the magnetic body and a first connection portion disposed on the first surface of the magnetic body; and
the second external electrode comprises a second electrode pad disposed on the sixth surface of the magnetic body and a second connection portion disposed on the second surface of the magnetic body.

5. The coil electronic component of claim 4, wherein:
the first electrode pad and the first connection portion are an integral structure with each other; and
the second electrode pad and the second connection portion are an integral structure with each other.

6. The coil electronic component of claim 4, wherein:
the first connection portion is spaced apart from the fifth surface of the magnetic body; and
the second connection portion is spaced apart from the fifth surface of the magnetic body.

7. The coil electronic component of claim 6, wherein:
the first connection portion is spaced apart from each of the third surface and the fourth surface of the magnetic body; and
the second connection portion is spaced apart from each of the third surface and the fourth surface of the magnetic body.

8. The coil electronic component of claim 1, wherein:
the coil is a wound coil.

9. The coil electronic component of claim 1, further comprising:
a support member disposed within the magnetic body, and comprising a first support surface and a second support surface facing each other,
wherein the coil comprises a first coil pattern disposed on the first support surface of the support member, a second coil pattern disposed on the second support surface of the support member, and a via connecting the first coil pattern and the second coil pattern.

10. The coil electronic component of claim 1, wherein:
the magnetic body is a stack of a plurality of sheets; and
the coil comprises a plurality of coil patterns disposed on respective sheets of the plurality of sheets and connected to each other.

11. The coil electronic component of claim 1, further comprising:
a fifth insulation layer disposed between the first external electrode and the second external electrode on the sixth surface of the magnetic body.

12. The coil electronic component of claim 11, wherein:
the fifth insulation layer is further disposed on the third surface, the fourth surface, and the fifth surface of the magnetic body.

13. A coil electronic component, comprising:
a magnetic body comprising a first surface and a second surface facing each other in a first direction, a third surface and a fourth surface facing each other in a second direction and connecting the first surface and the second surface, and a fifth surface and a sixth surface facing each other in a third direction and connecting the first surface and the second surface, the first and second surfaces including a first recess portion and a second recess portion, respectively, that are spaced apart from the fifth surface of the magnetic body;
a coil of which at least a portion is embedded in the magnetic body;
a first external electrode including a first electrode pad disposed on the sixth surface of the magnetic body and a first connection portion embedded in the first recess portion and connected to the coil; and
a second external electrode including a second electrode pad disposed on the sixth surface of the magnetic body and a second connection portion embedded in the second recess portion and connected to the coil.

14. The coil electronic component of claim 13, wherein
each of the first and second recess portions is spaced apart from the third surface and the fourth surface of the magnetic body such that the first and second connection portions are spaced apart from the third surface and the fourth surface of the magnetic body.

15. The coil electronic component of claim 14, further comprising:
a first insulation layer covering the first connection portion embedded in the first recess portion; and
a second insulation layer covering the second connection portion embedded in the second recess portion.

16. The coil electronic component of claim 15, further comprising:
a third insulation layer surrounding edges of the first connection portion facing the third surface, the fourth surface and the fifth surface of the magnetic body; and
a fourth insulation layer surrounding edges of the second connection portion facing the third surface, the fourth surface and the fifth surface of the magnetic body.

17. The coil electronic component of claim 16, further comprising:
a fifth insulation layer disposed between the first electrode pad and the second electrode pad on the sixth surface of the magnetic body.

18. The coil electronic component of claim 17, further comprising:
at least one plating layer disposed on the first electrode pad and the second electrode pad,
wherein an outer surface of the at least one plating layer protrudes from an outer surface of the fifth insulation layer in the third direction.

19. The coil electronic component of claim 18, wherein:
the first and second insulation layers further extend from outer surfaces of the first and second electrode pads in the third direction, and
a side surface of the at least one plating layer abuts onto a side surface of the first insulation layer or the second insulation layer in the first direction.
